(19) United States
(12) Patent Application Publication
(10) Pub. No.: US 2011/0227015 A1
(43) Pub. Date: Sep. 22, 2011

(54) SNOW PLOW BARRIER SYSTEMS

(76) Inventor: Ellsworth Perryman, Mississauga (CA)

(21) Appl. No.: 13/043,459

(22) Filed: Mar. 8, 2011

Related U.S. Application Data
(60) Provisional application No. 61/316,041, filed on Mar. 22, 2010.

(51) Int. Cl. E04H 17/16; B23P 11/00

(52) U.S. Cl. 256/19; 256/24; 29/428

(57) ABSTRACT

Snow Plow Barrier Systems is a modular barrier assembly for blocking snow from being pushed into a user-preferred protected area. Snow Plow Barrier Systems comprises a plurality of angle-adjustable and removably inter-connectable rectangular barrier boards. Each barrier board comprises a retractable leg stand which may pivot to three different positions and a handle with a grip for easy transport. In a preferred embodiment and manner of use of the present invention, at least two barrier boards are slidably connected via a pair of receivers and fittings located on the sides of each barrier board thereby creating a wall assembly. The Snow Plow Barrier Systems may be positioned in front of a home owner's driveway and may serve to deflect snow from a passing snow plow from being pushed onto the home owner's driveway or other property.

### CROSS-REFERENCE TO RELATED APPLICATION

The present application is related to and claims priority from prior provisional application Ser. No. 61/316,041, filed Mar. 22, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of barriers and more specifically relates to a portable, self-standing barrier for blocking snow from being plowed into a protected area.

### 2. Description of the Related Art

During periods of high snow volume, plow trucks are needed to clear the streets. As plows move along, they may push excess snow off to the sides. In residential areas, the snow collects into piles in front of driveways, filling any available space. This may prevent consumers from being able to drive their cars out of their driveways. Shoveling these large piles of tightly-packed snow can be difficult and time consuming, as the snow is often very heavy. Extended periods of shoveling heavy snow may cause consumers to incur back injuries, frostbite, and contribute to other serious health conditions.

Barriers may be employed to protect an area from intrusion. Barriers are available in a variety of shapes and sizes. Further, barriers may be constructed of different materials to block substances of various types. Typically, barriers are often used because they are free standing and therefore passively provide the service of inhibiting the passage of unwanted objects. However, despite the wide range of uses that barriers serve, home owners in residential areas are still plagued by unnecessary hours of dealing with snow that has been pushed onto their property by passing street plows. Consequently, the driveway and sidewalk areas may be covered in heavy snow that must be removed by the home owner.

Various attempts have been made to solve the above-mentioned problems such as those found in U.S. Pub. No. 2010/0243977; U.S. Pat. Nos. 5,550,349; 4,498,660; 4,783,934; and 3,830,031. This prior art is representative of barriers. None of the above inventions and patents, taken either singly or in combination, is seen to describe the invention as claimed.

Ideally, a snow plow barrier should be self-standing, easy to connect to other barriers, and convenient to store, and, yet, would operate reliably and be manufactured at a modest expense. Thus, a need exists for a reliable, modular snow plow barrier that may be used to block plowed snow from entering a user-preferred protected area, and to avoid the above-mentioned problems.

### BRIEF SUMMARY OF THE INVENTION

In view of the foregoing disadvantages inherent in the known snow bather art, the present invention provides a novel bather to protect an area from plowed snow. The general purpose of the present invention, which will be described subsequently in greater detail, is to provide a modular bather to shield an area from snow entering as a result of a snow plow.

Snow Plow Barrier Systems is a modular barrier assembly for blocking snow from being pushed into a user-preferred protected area. Snow Plow Barrier Systems preferably comprises a plurality of angle-adjustable and removably inter-connectable rectangular barrier boards. Each barrier board comprises a retractable leg stand which may pivot to at least three different positions and a handle with a grip for easy transport. In a preferred embodiment and manner of use of the present invention, at least two barrier boards are slidably connected via a pair of inserters and receivers located on the sides of each barrier board thereby creating a wall assembly. The Snow Plow Barrier Systems may be positioned in front of a home owner's driveway and may serve to deflect snow from a passing snow plow from being pushed onto the home owner's driveway or other property.

The barrier board of the present invention may comprise a high-grade and durable plastic material. The barrier board may comprise a handle located along the top for easy transport. Further, grips comprising vertical indentures may be located along the top and bottom surface of the barrier board. The grips may assist the user in handling the barrier board.

The barrier board may comprise a pair of inserters on located along a first edge of barrier board. Further, barrier board may comprise a pair receivers on an opposite side. In use, the pair of inserters on a first barrier board are slidably insertable into the pair of receivers on a second barrier board thereby forming a wall barrier.

The retractable leg assembly may comprise a leg stand, a leg stand fastener, pivoter, and a plurality of pivoter grooves. The leg stand may be attachable to the barrier board via the leg stand fastener. The leg stand may swing inwardly and outwardly via the pivoter. The leg stand may be pivoted into one of the pivoter grooves where it may be held in place. The retractable leg may serve a supporting stabilizer for the barrier board assembly while in an in-use condition. In a preferred embodiment of Snow Plow Barrier Systems, barrier board assembly comprises three angles measuring approximately 10 degrees, 15 degrees, and 20 degrees respectively.

During a snow storm, a user may connect a plurality of bather boards together via the inserters and receivers without the need of a separate hinge assembly. Further, a user may construct a modular barrier assembly to a user preferred size thereby providing maximum protection from a passing snow plow. Snow Plow Barrier Systems may be used to shield a driveway, walkway, sidewalk, or other property from passing snow plows.

The present invention holds significant improvements and serves as a snow plow barrier system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, snow plow barrier systems, constructed and operative according to the teachings of the present invention.

FIG. 1 shows a perspective view illustrating snow plow barrier systems in an in-use condition according to an embodiment of the present invention.

FIG. 2 is a front perspective view illustrating a barrier board according to an embodiment of the present invention of FIG. 1.

FIGS. 3A-3C are perspective views illustrating a back side of the barrier board comprising a retractable leg assembly according to an embodiment of the present invention of FIG. 1.

FIGS. 4A-4C are side perspective views of the pivotal angles of the retractable leg assembly according to an embodiment of the present invention of FIG. 1.

FIG. 5 is perspective views illustrating a barrier board assembly comprising two connected bather boards according to an embodiment of the present invention of FIG. 1.

FIG. 6 is a perspective view illustrating a plurality of connected barrier boards comprising a snow bather wall structure in an in-use condition according to an embodiment of the present invention of FIG. 1.

FIG. 7 is a flowchart illustrating a method of use of snow plow bather systems according to an embodiment of the present invention of FIGS. 1-6.

The various embodiments of the present invention will hereinafter be described in conjunction with the appended drawings, wherein like designations denote like elements.

### DETAILED DESCRIPTION

As discussed above, embodiments of the present invention relate to a snow plow barrier system, and more particularly to a modular bather assembly comprising a plurality of angle-adjustable, connectable barrier boards that may be particularly used for blocking snow from being plowed into a user-preferred protected area. User-preferred protected area comprises a driveway, sidewalk, lawn or other.

It is not uncommon for snow plows, either privately-owned/operated or publicly-funded, to plow residential/commercial areas after a bad snow storm. In fact, many snow plows may visit the same area at least twice in a day if the snow storm is ongoing to ensure safe roads. Home owners across the snow-affected areas may appreciate the frustration of not having to shovel and re-shovel plowed snow off of driveways and walkways as a result of snow being pushed onto their property by the snow plow. Because the snow that is pushed onto the home owner's property has been condensed and packed in from the pushing force of the plow and the cold temperature of the storm, this snow is often more difficult to shovel and remove as a result. Furthermore, the act of shoveling snow off of one's property is often a trying and rigorous task. Shoveling involves bending, lifting, and enduring cold weather. The additional and unnecessary exposure to the outdoors resulting from re-shoveling the same snow may result in injury to the legs, back, or neck, or may result in the catching of a cold or worse. A primary objective of the present invention is to provide home owners with a solution that may suitably deflect snow from a snow plow effectively preventing it from entering their property.

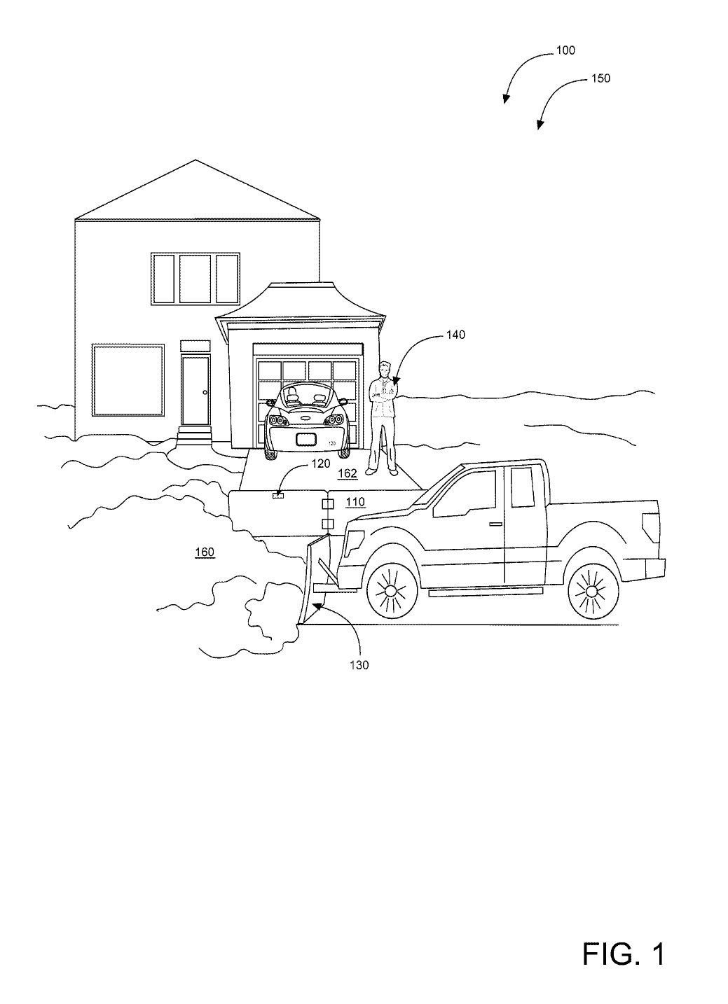

In referring to the accompanying illustrations, there is shown in FIG. 1 a perspective view of snow plow barrier systems 100 in an in-use condition 150 according to an embodiment of the present invention. As illustrated in FIG. 1, snow 160 is accumulating as a result of a snow storm. Snow plow bather systems 100 may generally comprise barrier board assembly 110 which may be positioned in front of driveway 162 as shown. In such a manner, barrier board assembly 110 may serve to prevent snow 160 from being pushed onto driveway 162 by snow plow 130. User 140 may easily assemble bather board assembly 110 and may transport barrier board assembly 110 via handle 120 to a desired location. Here, barrier board assembly 110 may be used residentially to prevent unnecessary shoveling of snow as a result of snow plow 130 pushing snow onto the property of user 140.

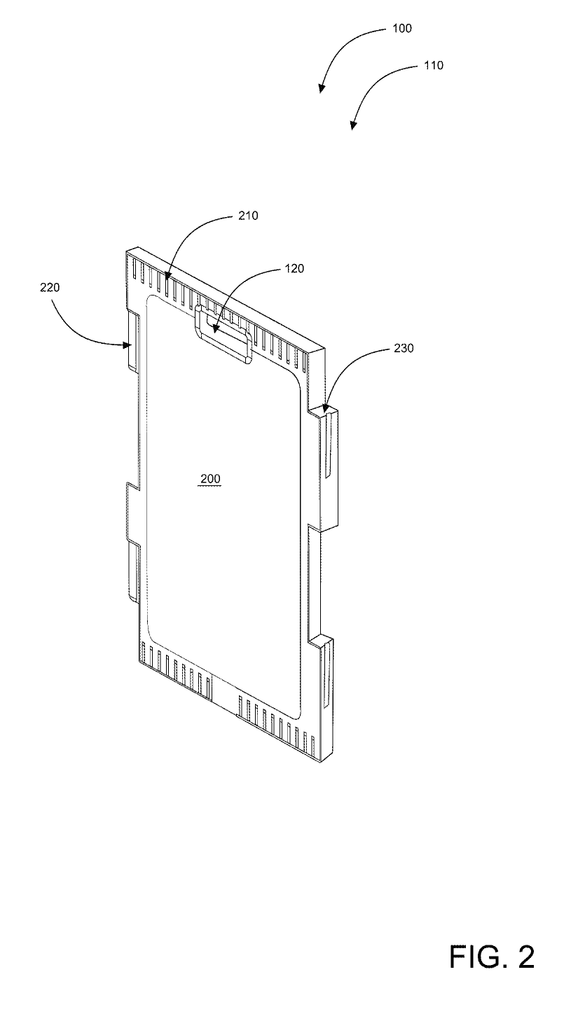

FIG. 2 is a perspective view illustrating of barrier board 200 from a front position according to an embodiment of the present invention of FIG. 1. Barrier board 200 may comprise a rectangular (or square or other suitable shape), high-grade sturdy plastic material which may effectively serve to withstand pushing force of snow 160 being moved by snow plow 130. Barrier board 200 preferably measures approximately four feet wide and two feet tall. As may be seen in FIG. 2, barrier board 200 comprises handle 120 situated at the top of barrier board 200 for convenient transport by user 140. Further, a plurality of vertical indentures comprising grips 210 may be located along the top and bottom of barrier board 200. Grips 210 may serve to assist user 140 in handling barrier board 200. Further, grips 210 may provide a more aesthetically pleasing appearance of barrier board assembly 110. Grips 210 combine to provide a lowered center of gravity inertia absorber to stay stable for when snow 160 is pushed against barrier board(s) 200.

In still referring to FIG. 2, barrier board 200 may comprise two inserters 220 on a first side of barrier board 200. Inserters 220 may comprise a plastic fitting. Further, barrier board 200 may comprise two receivers 230 on a second side of barrier board 200. Receivers 230 may comprise a groove space. It should be noted that inserters 220 located on a first side of barrier board 200 are symmetrically positioned parallel to receivers 230 located on opposite side of barrier board 200. In such a manner, inserters 220 of a first barrier board 200 may be slidably insertable into receivers 230 of a second barrier board 200.

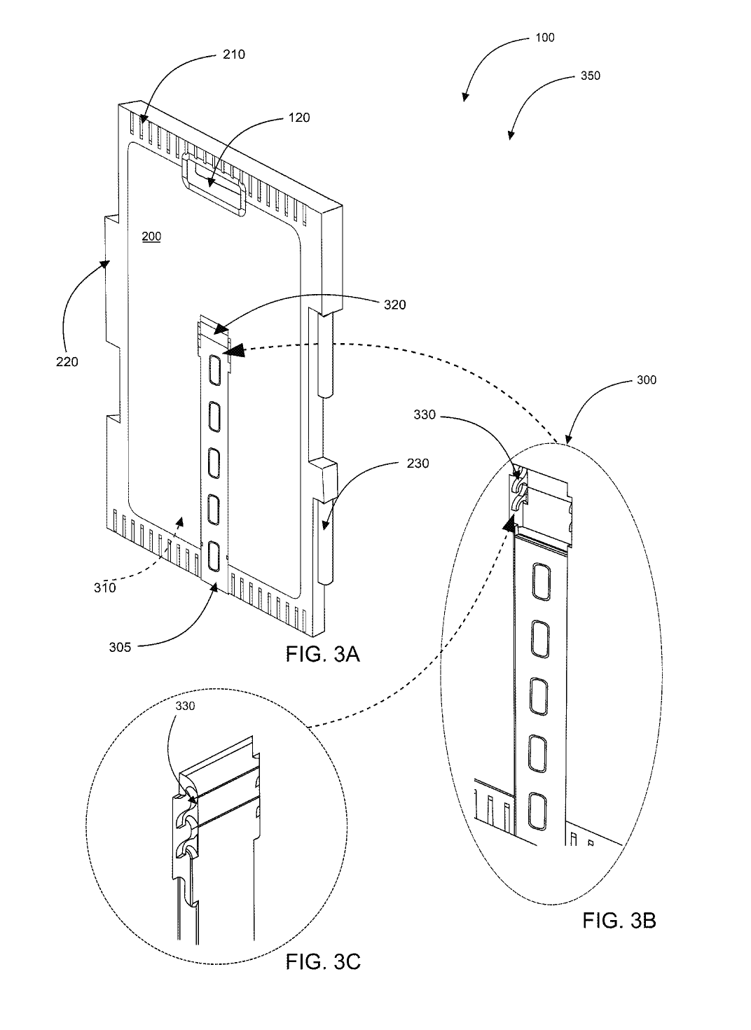

FIGS. 3A-3C show perspective views of a back side of barrier board 200 comprising retractable leg assembly 300 according to an embodiment of the present invention of FIG. 1. As illustrated in FIG. 3A, barrier board 200 may comprise retractable leg assembly 300 which may fit within leg compartment 310. FIGS. 3B and 3C illustrate a preferred embodiment of retractable leg assembly 300 comprising leg stand 305, leg stand fastener 315, and pivoter 320. Leg stand 305 may be connected to barrier board 200 via leg stand fastener 315. As best shown in FIG. 3B, leg stand 305 is preferably swingably mountable to barrier board 200 and may be stored in leg compartment 310 wherein leg compartment 310 comprises a recess within barrier board 200 measuring the volume of leg stand 305. Further, as best seen in FIG. 3C, retractable leg assembly 300 may comprise pivoter grooves 330. Pivotor groove 330 may comprise an indenture for securably holding pivoter 320. Preferably, retractable leg assembly 300 comprises three pivoter grooves 330 thereby providing three different angles for barrier board assembly 110 in an in-use condition 150. It should be appreciated that in alternative embodiments of retractable leg stand assembly 300, there may be a plurality of pivoter grooves 330 or alternatively may be manufactured with only one pivoter groove 330. It should also be noted that retractable leg assembly 300 may comprise padding with grips at the base of leg stand 305. In use, the grips may provide further resistance to a pushing force caused by snow pushed by/from snow plow 130. In this way leg stand 305 comprises a base and base comprises a base pad. Base pad comprises grips on a bottom surface in certain embodiments.

Yet still referring to FIGS. 3A and 3B, illustrating snow plow barrier systems 100 in a stored condition 350. Retractable leg assembly 300 may be designed such that leg stand 305 is swingably mountable and may be housed within leg compartment 310 of barrier board 200 during periods of non-use. When snow plow barrier systems 100 is in stored condition 350, bather board assembly 110 may stand against a wall of a garage or may be positioned along the side of a closet. User 140 may therefore appreciate the space efficiency means of snow plow barrier systems 100. The present invention is storable in a garage in a planar configuration.

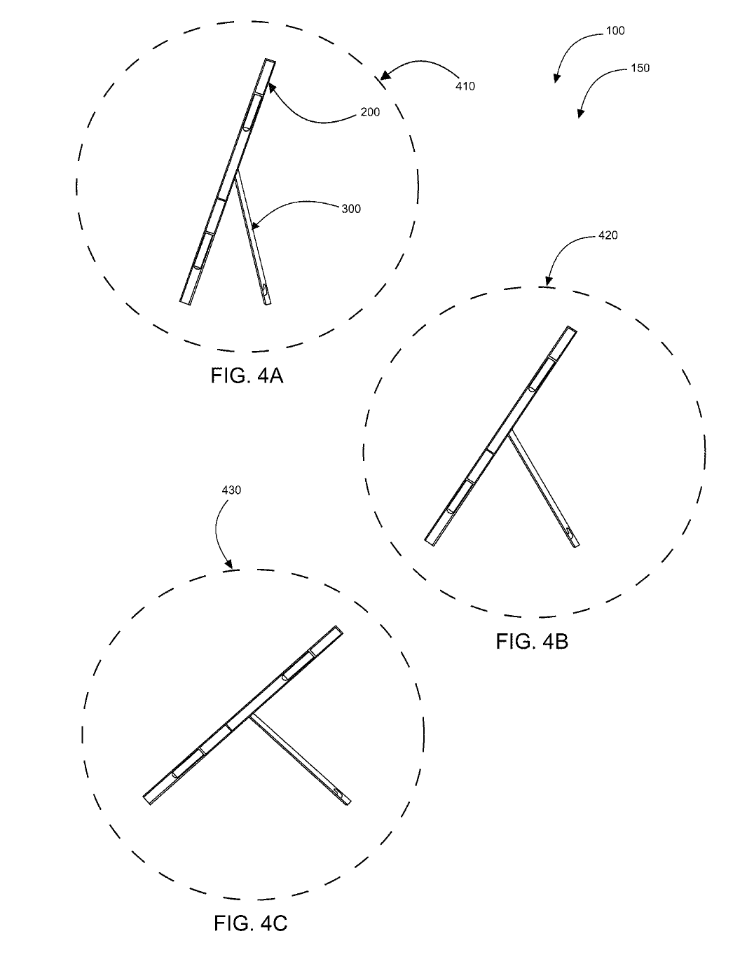

Now referring to FIGS. 4A-4C, illustrating side perspective views of the pivotal angles of retractable leg assembly 300 according to an embodiment of the present invention of FIG. 1. As shown in FIGS. 4A-4C, retractable leg assembly 300 comprising pivoter grooves 330 enable pivoter 320 to slidably adjust the angle of barrier board assembly 110 in an in-use condition. According to a preferred embodiment of the present invention, retractable leg assembly 300 may comprise three pivoter grooves 330 thereby enabling user 140 to select from three angle positions when positioning barrier board assembly 110. FIG. 4A illustrates first pivot position 410. First pivot position 410 may comprise an angle of approximately 10 degrees outward from bather board 200. As shown in FIG. 4B, second pivot position 420 may comprise an angle of approximately 15 degrees from barrier board 200. This may be the preferred position by user 140 to provide the greatest verticality of barrier board assembly 110 while optimizing the lowered center of gravity of leg stand 305 for absorbing inertia. As shown in FIG. 4C, third pivot position 430 may comprise an angle of approximately 20 degrees from barrier board 200. User 140 may utilize third pivot position 430 for heavier snow. Many angles of inclination are possible, however a few have been enabled as described herein, but these should not be considered to be limiting in any way.

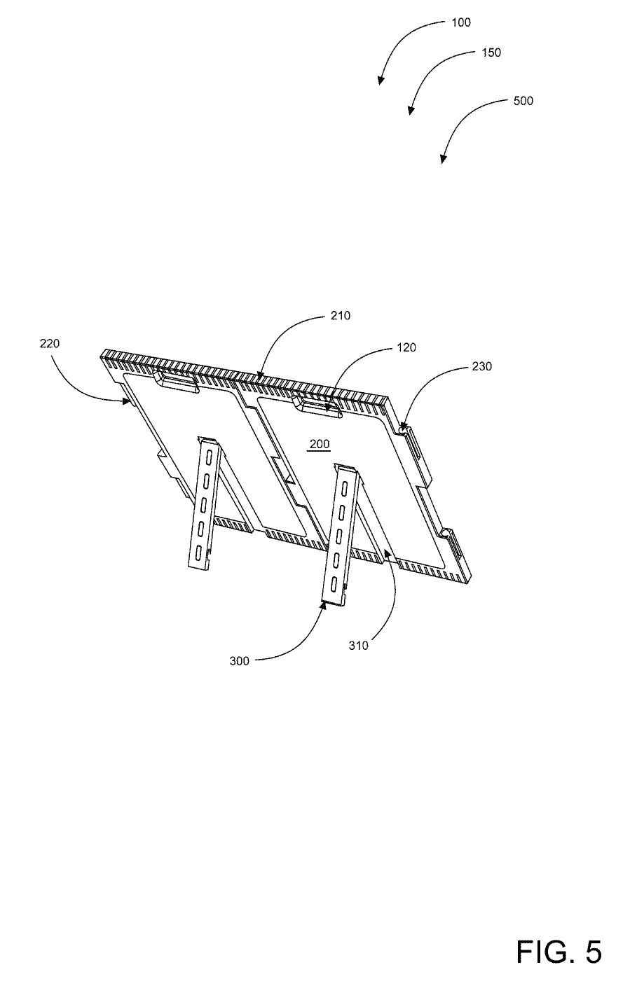

FIG. 5 is a rear perspective view illustrating snow barrier wall structure 500 comprising two connected barrier boards 200 according to an embodiment of the present invention of FIG. 1. The modular nature of snow plow barrier systems 100 may best be appreciated by having a plurality of barrier boards 200 connected to one another via integrated inserters 220 and receivers 230. Each barrier board 200 comprising retractable leg assembly 300 should be positioned at equal angles. User 140 may quickly and easily construct snow bather wall structure 500 using multiple bather boards 200 to protect a greater amount of space (area) from snow 160 pushed via snow plow 130.

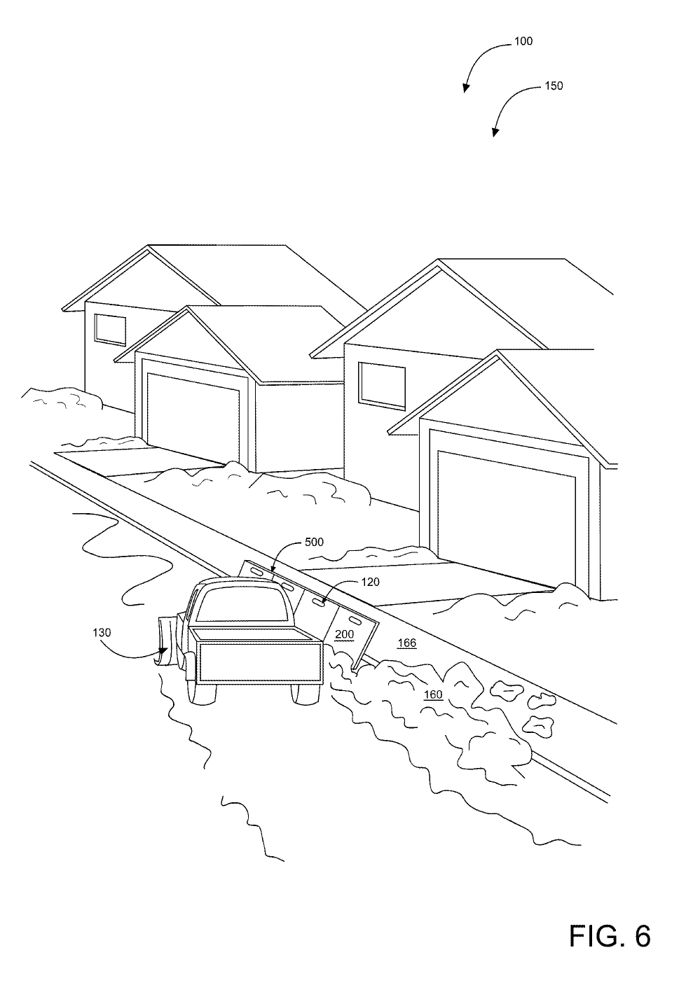

FIG. 6 is a perspective view illustrating snow barrier wall structure 500 in an in-use condition 150 according to an embodiment of the present invention of FIG. 1. As shown, snow bather wall structure 500 may be positioned adjacent to sidewalk 610. In such a manner, snow plow 130 that may be passing down the street cannot push snow 160 onto sidewalk 610. This may provide an effective solution for any property owner during a winter storm when snow 160 may accumulate.

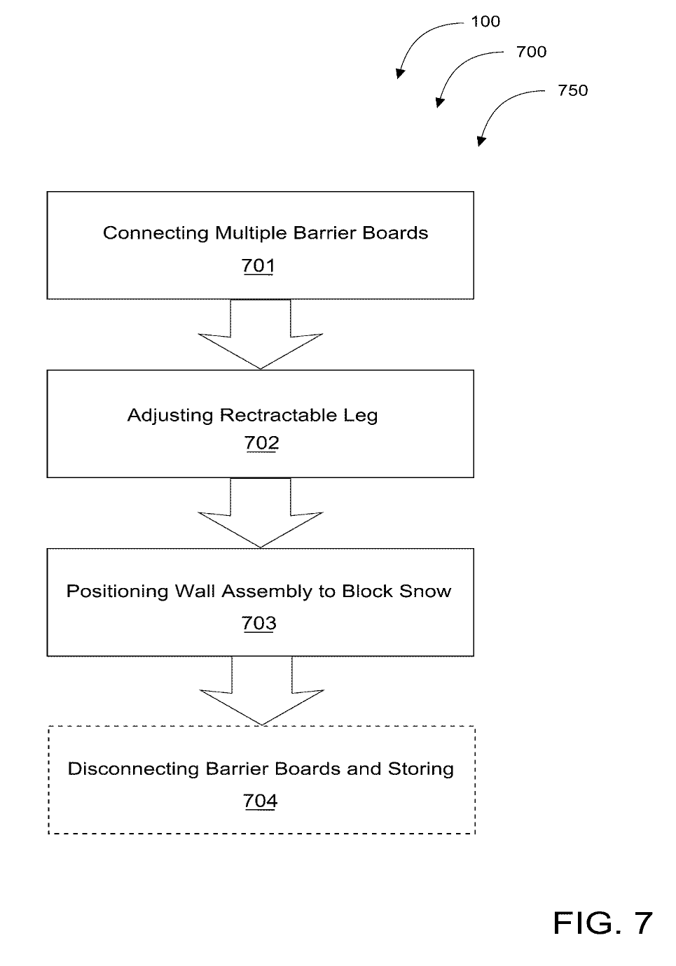

FIG. 7 is a flowchart illustrating method of use 700 of snow plow barrier systems 100 according to a preferred embodiment of the present invention of FIGS. 1-6. Method of use 700 may comprise the steps of: step one 701 connecting at least one barrier board 200 to another barrier board 200 thereby creating snow barrier wall structure 500, step two 702 adjusting retractable leg 305 of barrier board 200 to either first pivot position 410, second pivot position 420, third pivot position 430, step three 703 positioning barrier board assembly 110 to a user-preferred area to passively deflect snow 160 from snow plow 130, and step four 704 disconnecting barrier boards 200 and retracting leg 305 into leg compartment 310 for storage.

It should be noted that step four 704 is an optional step and may not be implemented in all cases. Optional steps of method of use 700 are illustrated using dotted lines in FIG. 7 so as to distinguish them from the other steps of method 700.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable modular barrier assembly for blocking snow on a planar surface comprising:
at least one rectangular barrier board;
at least one retractable leg assembly;
wherein said retractable leg assembly comprises at least one leg stand, at least one leg stand fastener, and at least one pivoter;
wherein said leg stand is connectable to said rectangular barrier board via said leg stand fastener;
wherein said leg stand is swingably mountable via said pivoter such that said leg stand swings outwardly from said rectangular barrier board;
wherein said retractable leg stand is positionable on said planar surface to provide a self-supporting stabilizer; and
wherein said portable modular barrier assembly passively serves to prevent snow from being pushed into a user-preferred protected area.

2. The portable modular barrier assembly of claim 1 wherein said rectangular barrier board comprises at least one through-hole comprising a handle.

3. The portable modular barrier assembly of claim 1 wherein said rectangular barrier board comprises at least one recess for accommodating said at least one retractable leg stand during a period of non-use.

4. The portable modular barrier assembly of claim 1 wherein said rectangular barrier board comprises heavy-duty plastic material.

5. The portable modular barrier assembly of claim 1 wherein said leg stand comprises a base.

6. The portable modular barrier assembly of claim 5 wherein said base comprises a base pad.

7. The portable modular barrier assembly of claim 6 wherein said base pad comprises grips on a bottom surface.

8. The portable modular barrier assembly of claim 7 wherein said leg stand comprising said grips combine to provide a lowered center of gravity inertia absorber.

9. The portable modular barrier assembly of claim 1 wherein said retractable leg stand assembly comprises at least three pivoter grooves that enable said pivoter to pivot to at least three different angles.

10. The portable modular barrier assembly of claim 9 wherein said angle comprises approximately 15 degrees from said rectangular barrier board while in an in-use condition.

11. The portable modular barrier assembly of claim 1 wherein said rectangular barrier board measures approximately four feet wide and two feet tall.

12. The portable modular barrier assembly of claim 1 wherein said rectangular barrier board comprises at least one pair of receivers on a first side of said rectangular barrier board and at least one pair of fittings on a second side of said rectangular barrier board.

13. The portable modular barrier assembly of claim 12, wherein said pair of receivers is constructed to slidably receive said pair of fittings such that said rectangular barrier board is removably connectable to an additional rectangular barrier board.

14. The portable modular barrier assembly of claim 13 wherein said rectangular barrier board is connectable to an unlimited amount of said rectangular barrier boards thereby creating a wall assembly.

15. The portable modular barrier assembly of claim 1 wherein said leg stand receiver comprises ferrous material.

16. The portable modular barrier assembly of claim 1 wherein said user-preferred protected area comprises a driveway.

17. The portable modular barrier assembly of claim 1 wherein said user-preferred protected area comprises a sidewalk.

18. The portable modular barrier assembly of claim 1 wherein said rectangular barrier board is storable in a garage in a planar configuration.

19. A portable modular barrier assembly for blocking snow on a planar driveway surface comprising:
at least two rectangular barrier boards comprising heavy-duty plastic material and having at least one through-hole comprising a handle, at least one recess, and measuring approximately four feet wide and two feet tall;
at least two retractable leg stands comprising bases having base pads comprising grips on a bottom surface of said base pads;
at least two leg stand receivers comprising ferrous or non-ferrous material and comprising a pivot;
wherein said at least two retractable leg stands are connectable to said barrier board via said at least two leg stand receivers;
wherein said at least two retractable leg stands are swingably mountable such that said retractable leg stands swing outwardly from said rectangular barrier board;
wherein said retractable leg stands are positionable on said planar driveway surface to provide a self-supporting stabilizer; and
wherein said portable modular barrier assembly passively serves to prevent snow from entering said planar driveway surface.

20. A method of using a portable modular barrier assembly comprising the steps of:
connecting at least two barrier boards together by insertably fitting the inserters of a first barrier board into the receivers of a second barrier board thereby creating said portable modular barrier assembly;
outwardly swinging retractable leg stands of said barrier boards to stabilize said portable modular barrier assembly;
positioning said portable modular barrier assembly to a user-preferred area to deflect snow; and
folding said retractable leg stands into a recess within said barrier board for storage of said portable modular barrier assembly.
